(19) United States
(12) Patent Application Publication
(10) Pub. No.: US 2026/0095454 A1
(43) Pub. Date: Apr. 2, 2026

(54) SYSTEM AND METHODS FOR TRACKING ACCESS TO USER DATA USING A DISTRIBUTED LEDGER AND ARTIFICIAL INTELLIGENCE

(71) Applicant: BANK OF AMERICA CORPORATION, Charlotte, NC (US)

(72) Inventors: Manu Kurian, Dallas, TX (US); Sandra L. Dube, Salt Lake City, UT (US); Marshall A. Johnson, Summit, NJ (US); Ana Maxim, Arlington, VA (US); Kathlyn Rooney, Boston, MA (US); Sarah E. Tripodi, Boston, MA (US); Michael R. Young, Davidson, NC (US)

(73) Assignee: BANK OF AMERICA CORPORATION, Charlotte, NC (US)

(21) Appl. No.: 18/904,520

(22) Filed: Oct. 2, 2024

(51) Int. Cl. H04L 9/40

(52) U.S. Cl. CPC H04L 63/101

(57) ABSTRACT

Systems, computer program products, and methods are described herein for tracking access to user data. The present invention is configured to receive user data, store the user data on a distributed ledger, estimate a value of the user data, store the estimated value, render a first GUI for receiving input identifying permission levels for public access to attributes of the user data, provide the first GUI to a user device, generate public attributes, store the public attributes, receive a search request from an entity comprising a list of attributes, generate a list of users with at least one attribute on the list of attributes, transmit the list of users, receive requests for access to subsets of user data, render a second GUI for receiving input identifying a response to the request, provide the second GUI to a user device, receive the response, and transmit the response to the entity.

### FIELD OF THE INVENTION

The present invention embraces a system for tracing and securing resource distribution provided secondary entity access to user data (e.g., a system for tracing used data by secondary entities, a system for tracking access to user data, and/or the like).

### BACKGROUND

Presently, users may share data with an entity for a purpose but have no control over and/or ability to track the entity using the data beyond the purpose and/or sharing the data with other entities.

Applicant has identified a number of deficiencies and problems associated with tracing and securing resource distribution provided secondary entity access to user data. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for tracking access to user data may include a network interface configured to communicate via a communication network, a non-transitory storage device including computer program code stored thereon, and/or a processing device operably coupled to the network interface, and/or the non-transitory storage device. In some embodiments, the computer program code may include computer instructions configured to cause the processing device to receive, using the network interface, user data associated with a user, store the user data on a distributed ledger, estimate a value of the user data, store the estimated value of the user data on the distributed ledger, render a first graphical user interface (GUI) for receiving, from the user, input identifying permission levels for public access to attributes of the user data, provide, using the network interface, the first GUI to a user device associated with the user for display to the user, generate, using the network interface, public attributes of the user data, store the public attributes of the user data on the distributed ledger, receive a search request from an entity comprising a list of attributes, generate a list of users with public attributes on the distributed ledger with at least one attribute on the list of attributes, transmit the list of users to the entity, receive, from the entity, requests for access to subsets of user data of a plurality of users from the list of users, render a second GUI for receiving, from the user, input identifying a response to the request for the entity, provide, using the network interface, the second GUI to a user device associated with the user for display to the user, receive, from the user device and using the network interface, the response for the entity input by the user using the second GUI, and transmit the response, using the network interface, to the entity.

In some embodiments, each request for access of the requests for access from the entity to the plurality of users may include a subset of user data the entity is allowed to access, a duration of allowed use of the subset of the user data, restrictions on the allowed use of the subset of the user data, permissions regarding the entity distributing access to the subset of the user data to other entities, and an offer of resources provided by the entity for access to the subset of the user data. Further, the response to the request may include an agreement to the request, a rejection of the request, or an amendment to terms of the request. Additionally, and/or alternatively, the computer program code may include computer instructions configured to cause the processing device to, if the request comprises an agreement, generate, using the network interface, a smart contract on the distributed ledger that permits devices with a token to access the subset of the user data, and provide, using the network interface, the token to a device associated with the entity.

In some embodiments, the system may include a generative AI model configured to receive, using the network interface, the requests for access to subsets of user data of the plurality of users from the list of users, analyze the requests for access, generate data of the requests for access, analyze a request of the requests for access, generate a recommendation for the request, and transmit, using the network interface, the data of the requests for access and the recommendation for the request to a user associated with the request. Further, the generative AI model may be configured to translate a name of an entity into a user-friendly form. Additionally, and/or alternatively, the system may be configured to render a third GUI comprising an up-to-date list of entities with active access to a subset of the user data, and provide, using the network interface, the third GUI to the user device associated with the user for display to the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of a system for tracing and securing transaction provided secondary entity access to user data, in accordance with an embodiment of the disclosure;

FIG. 2 illustrates an exemplary artificial intelligence (AI) engine subsystem architecture, in accordance with an embodiment of the disclosure;

FIGS. 3A and 3B illustrate a process flow for tracing used data by secondary entities, in accordance with an embodiment of the disclosure;

FIG. 4 illustrates another process flow for tracing used data by secondary entities, in accordance with an embodiment of the disclosure;

FIG. 5 illustrates another process flow for tracing used data by secondary entities, in accordance with an embodiment of the disclosure;

FIG. 6 illustrates another process flow for tracing used data by secondary entities, in accordance with an embodiment of the disclosure;

FIGS. 7A and 7B illustrate a process flow for tracking access to user data, in accordance with an embodiment of the disclosure;

FIG. 8 illustrates another process flow for tracking access to user data, in accordance with an embodiment of the disclosure;

FIG. 9 illustrates another process flow for tracking access to user data, in accordance with an embodiment of the disclosure; and

FIG. 10 illustrates another process flow for tracking access to user data, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

Presently, users may share data with an entity for a purpose but have no control over and/or ability to track the entity using the data beyond the purpose and/or sharing the data with other entities. Users may share a large amount of data as a part of their “online being.” Further, users may often choose whom they wish to share parts of and/or all of the data associated with themselves; however, user may have little to no control over how the shared data is used by the recipient and/or who the recipient may share the data with.

Embodiments of the present disclosure may leverage a distributed ledger combined with AI models to better track user data and whom the user data is being shared to. In such embodiments, users may understand and/or control who has access to their data. Further, user data may be prevented from being copied beyond the distributed ledger system. In some embodiments, a user may have an ability to set permission levels on their data on the distributed ledger such that entities may not access their data, may access subsets of their data, and/or may access all their data. Additionally, and/or alternatively, users may receive a resource transfer from an entity receiving a selected permission level by the entity from the user.

Accordingly, the present invention includes a system, computer program, and/or method for tracing used data by secondary entities. In some embodiments, a distributed ledger may include data associated with a plurality of users. In such embodiments, the data associated with each user may include biometric data (e.g., physical characteristics and/or behavioral characteristics), personal identification data, transactional data, social data, location data, and/or the like. Further, the distributed ledger may be configured to allow an owner of the data associated with a user (e.g., the user, a caretaker of the user, a parent of the user, a steward of the user, and/or the like) to set permissions for use of the data associated with the user.

In some embodiments, the data on the distributed ledger may be encrypted such that unauthorized entities may not access the data. Further, unauthorized entities may become authorized entities of data associated with a user by meeting permission requirements set by an owner of the data associated with the user. For example, an unauthorized entity may transmit a request for access to the data or a subset of the data associated with a user to the owner of the data associated with the user on the distributed ledger. The owner may review the request for access and may decide to grant permission to the unauthorized entity or may refuse permission to the unauthorized entity. In some embodiments, permission may include indefinite access to a subset of data or all data associated with a user, definite (e.g., a set period of time) access to a subset of data or all data associated with a user, an ability to grant permission to access a subset of data or all data associated with a user to other entities, and/or the like. Further, the distributed ledger may be configured to maintain an up-to-date list of active users of the data associated with a user for each user. Additionally, and/or alternatively, if permission has been granted to an entity to grant access to data of a user to other entities, the distributed ledger may be configured to generate a mapping tree (e.g., a tree that shows how permission of access to data associated with a user is being granted).

In some embodiments, the data on the distributed ledger may be further encrypted such that the data may not be useful and/or may not be passed beyond a subsystem associated with the distributed ledger. For example, if an entity is granted access to data associated with a user, a token (e.g., a key) may be transmitted to the entity. When the subsystem is presented the token, the subsystem may be configured to request the data from the distributed ledger, generate a data packet of the data, present the data packet to the entity, and/or purge the data packet (e.g., the entity no longer needs the data, the token includes a timed duration that has passed, and/or the like). In such embodiments, the data may not be distributed and/or broadcasted outside of the subsystem. In this way, each entity receiving data associated with a user may not access the data outside of the distributed ledger system (e.g., the distributed ledger may be a centralized access point). In some embodiments, permissions associated with the data of the distributed ledger may be based around regional data requirements.

In some embodiments, the distributed ledger may be operatively coupled with an AI model configured to make decisions. Further, the AI model may be configured to generate a threat determination for requests for access to user data. Additionally, the AI model may generate a binary determination (e.g., a yes or a no) to a request and/or a threat level determination (e.g., a score of the threat level of the request) and the AI model may transmit the determination to the owner associated with the requested data. In some embodiments, low level requests (e.g., requests for non-sensitive data) may be automatically approved by the AI model.

In another aspect, the present invention includes a system, computer program, and/or method for tracking access to user data. In some embodiments, the distributed ledger may include data associated with a plurality of users. In such embodiments, the data associated with each user may include biometric data (e.g., physical characteristics and/or behavioral characteristics), personal identification data, transactional data, social data, location data, and/or the like. Further, the distributed ledger may be configured to allow an owner of the data associated with a user (e.g., the user, a caretaker of the user, a parent of the user, a steward of the user, and/or the like) to set permissions for use of the data associated with the user.

In some embodiments, the distributed ledger may be configured to log a value of the data (e.g., an estimate of how much an owner should receive for access to the data) associated with a user for each user. Further, the distributed ledger may be configured to generate, with the permission of an owner of data associated with a user, public data of attributes (e.g., non-sensitive data that describes traits of the user) of the user. In such embodiments, an entity may be able to search for users with a set of attributes the entity wants to receive data on. For example, a company that generates a product may search for attributes that may be associated with the product. The company may request access to the user data for each user with the searched attributes, so that the company may market and/or offer the product to each user.

In some embodiments, a request for access to user data may include an offer of compensation for the data (e.g., money). Further, an owner of data associated with a user may respond to the request for access to user data with additional terms for granting access to the data (e.g., more money, a limit to the duration of access to the data, and/or the like). Additionally, a request for access to user data may include a request to license the data (e.g., an entity with access to the data may grant access to the data to other entities).

In some embodiments, the distributed ledger may be operatively coupled to a generative AI model configured to analyze requests for access to user data on the distributed ledger. In such embodiments, the generative AI model may analyze all requests occurring on the distributed ledger such that the generative AI model may generate data associated with requests (e.g., how many owners have received this request, what level of information is being requested, what will the data be used for, what kind of entity is requesting the data, and/or the like). Further, the generative AI model may be configured to transmit a summary of the generative AI model's finding on the request to the recipients of the request and may suggest a best course of action for the user (e.g., request more money, deny the request, accept the request, and/or the like). Additionally, the generative AI model may be configured to automatically grant access to requests based on permissions set by an owner of data associated with a user, bundle requests for certain types of data to an owner, and/or translate entity names into an understandable form for an owner.

What is more, the present invention provides a technical solution to a technical problem. As described herein, the technical problem includes a lack of ability for users to track and/or control the repurpose and/or sharing of data, shared by a user, by an entity. Additionally, and/or alternatively, the technical problem includes a lack of facilitation for users to exchange data associated with a user for resources associated with an entity. The technical solution presented herein allows for a distributed ledger operatively coupled with a plurality of AI models to track access to user data, permit or deny access to user data, recommend responses to requests for access to user data, and/or facilitate data for resource exchanges. In particular, the system for tracing and securing resource distribution provided secondary entity access to user data is an improvement over existing solutions to the lack of user-friendly systems for tracking data associated with a user and/or facilitating data for resource exchanges with entities, (i) with fewer steps to achieve the solution, thus reducing the amount of computing resources, such as processing resources, storage resources, network resources, and/or the like, that are being used (e.g., by aggregating all user data of a user and all records of permitted entities to the user data into a single source, a distributed ledger, the system reduces the amount of resources spent storing, processing, and/or transmitting data), (ii) providing a more accurate solution to problem, thus reducing the number of resources required to remedy any errors made due to a less accurate solution (e.g., by leveraging AI models for recommendations, the system may reduce the amount of unauthorized entities accessing user data thus reducing the number of resources spent removing access to user data by unauthorized entities), (iii) removing manual input and waste from the implementation of the solution, thus improving speed and efficiency of the process and conserving computing resources (e.g., by leveraging decision maker AI models, requests for access to user data below a selected threshold by a user may be automatically accepted, reducing manual input into the system), (iv) determining an optimal amount of resources that need to be used to implement the solution, thus reducing network traffic and load on existing computing resources (e.g., by using a distributed ledger operatively coupled with a subsystem configured for transmitting the permissioned data for viewing by an entity, the system reduces the amount of network resources spent transferring excess data). Furthermore, the technical solution described herein uses a rigorous, computerized process to perform specific tasks and/or activities that were not previously performed. In specific implementations, the technical solution bypasses a series of steps previously implemented, thus further conserving computing resources.

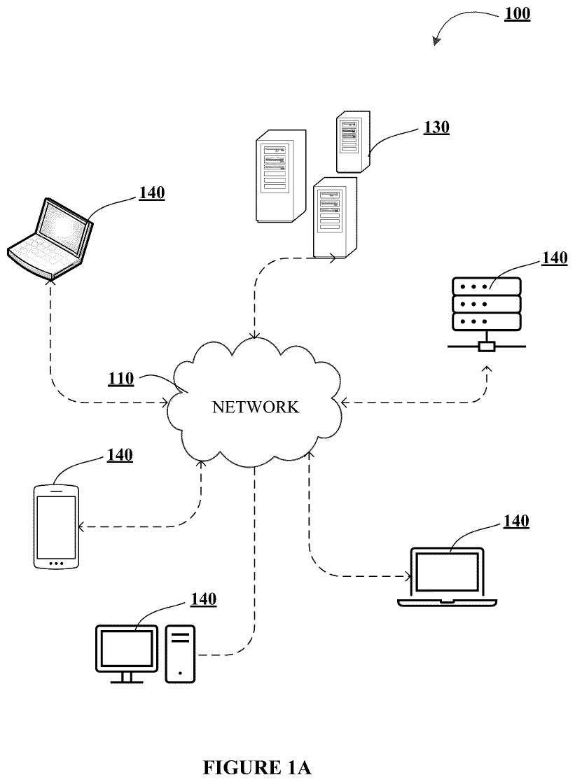

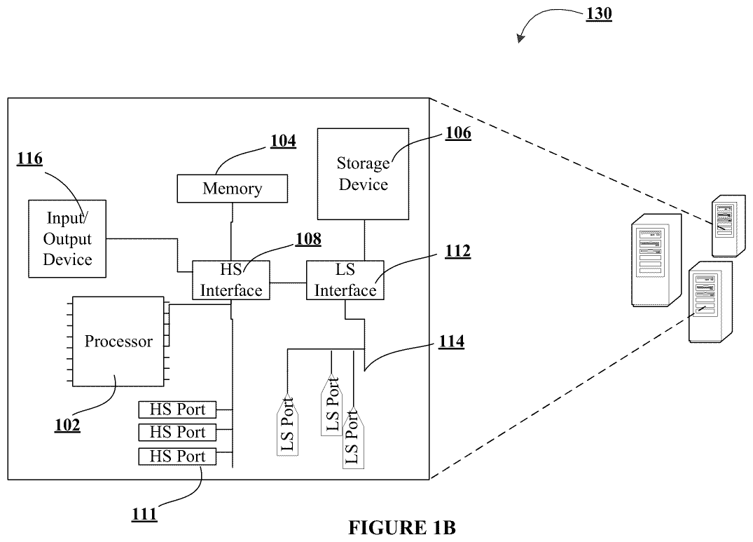

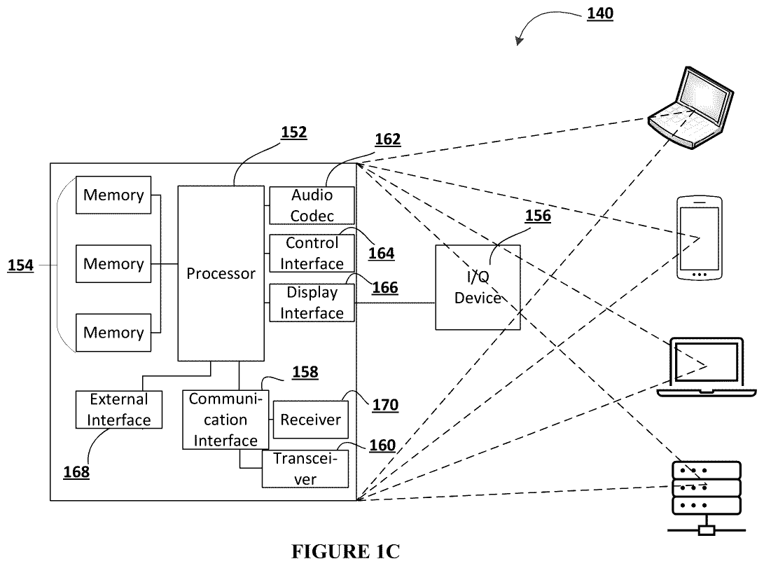

FIGS. 1A-1C illustrate technical components of a system for tracing and securing resource distribution provided secondary entity access to user data, in accordance with an embodiment of the invention. As shown in FIG. 1A, the distributed computing environment 100 contemplated herein may include a system 130 (e.g., an adaptable drift management system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, a multi-processor system, and/or the like).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

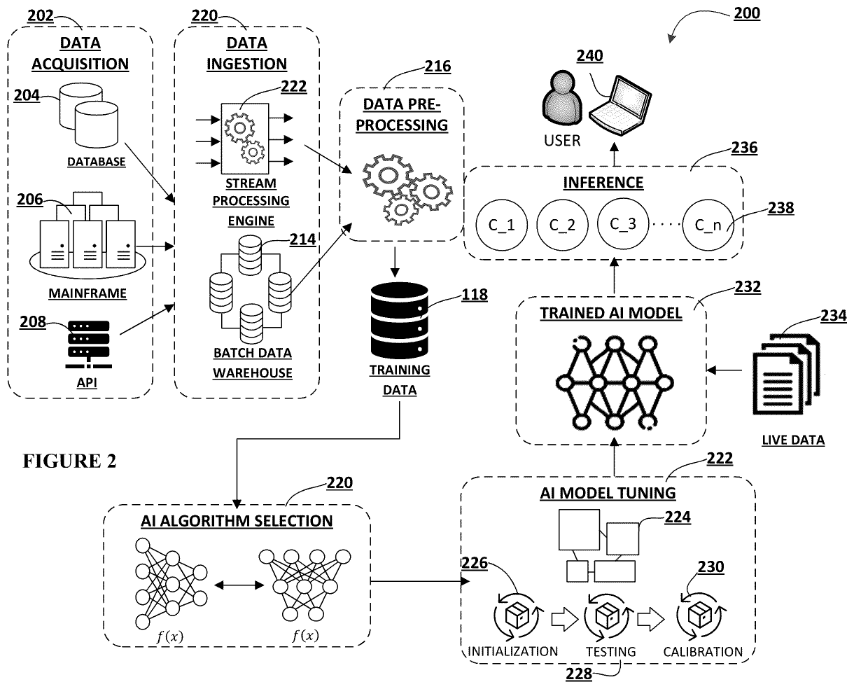

FIG. 2 illustrates an exemplary artificial intelligence (AI) engine subsystem architecture 200, in accordance with an embodiment of the disclosure. In some embodiments, the AI engine subsystem 200 may be included in a system (e.g., similar to the system 130 shown and described herein with respect to FIGS. 1A-1C, a tracing and securing resource distribution provided secondary entity access to user data, and/or the like). Additionally, or alternatively, the AI engine subsystem 200 may be a subsystem of another system (e.g., similar to the system 130 shown and described herein with respect to FIGS. 1A-1C) that is in communication with a tracing and securing resource distribution provided secondary entity access to user data (e.g., via a network similar to the network 110 as shown and described herein with respect to FIGS. 1A-1C). The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, and/or the like), unsupervised learning (e.g., using an Apriori algorithm, using K-means clustering, and/or the like), semi-supervised learning, reinforcement learning (e.g., using a Q-learning algorithm, using temporal difference learning, and/or the like), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, and/or the like), an instance-based method (e.g., k-nearest neighbor, learning vector quantization, self-organizing map, and/or the like), a regularization method (e.g., ridge regression, least absolute shrinkage and selection operator, elastic net, and/or the like), a decision tree learning method (e.g., classification and regression tree, iterative dichotomiser 3, C4.5, chi-squared automatic interaction detection, decision stump, random forest, multivariate adaptive regression splines, gradient boosting machines, and/or the like), a Bayesian method (e.g., naïve Bayes, averaged one-dependence estimators, Bayesian belief network, and/or the like), a kernel method (e.g., a support vector machine, a radial basis function, and/or the like), a clustering method (e.g., k-means clustering, expectation maximization, and/or the like), an associated rule learning algorithm (e.g., an Apriori algorithm, an Eclat algorithm, and/or the like), an artificial neural network model (e.g., a Perceptron method, a back-propagation method, a Hopfield network method, a self-organizing map method, a learning vector quantization method, and/or the like), a deep learning algorithm (e.g., a restricted Boltzmann machine, a deep belief network method, a convolution network method, a stacked auto-encoder method, and/or the like), a dimensionality reduction method (e.g., principal component analysis, partial least squares regression, Sammon mapping, multidimensional scaling, projection pursuit, and/or the like), an ensemble method (e.g., boosting, bootstrapped aggregation, AdaBoost, stacked generalization, gradient boosting machine method, random forest method, and/or the like), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

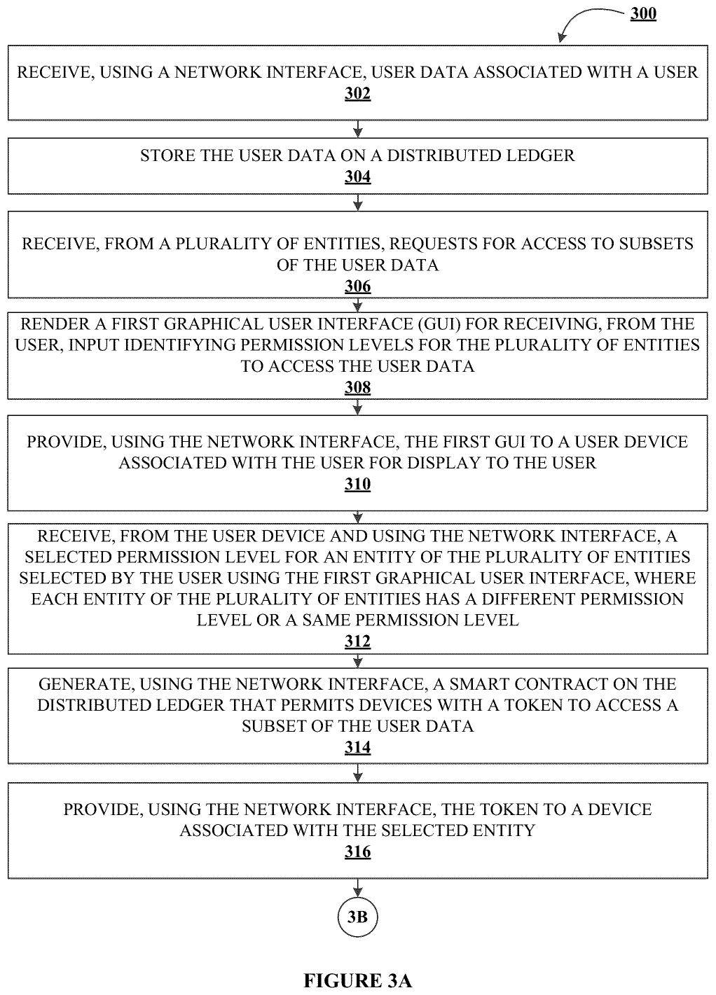

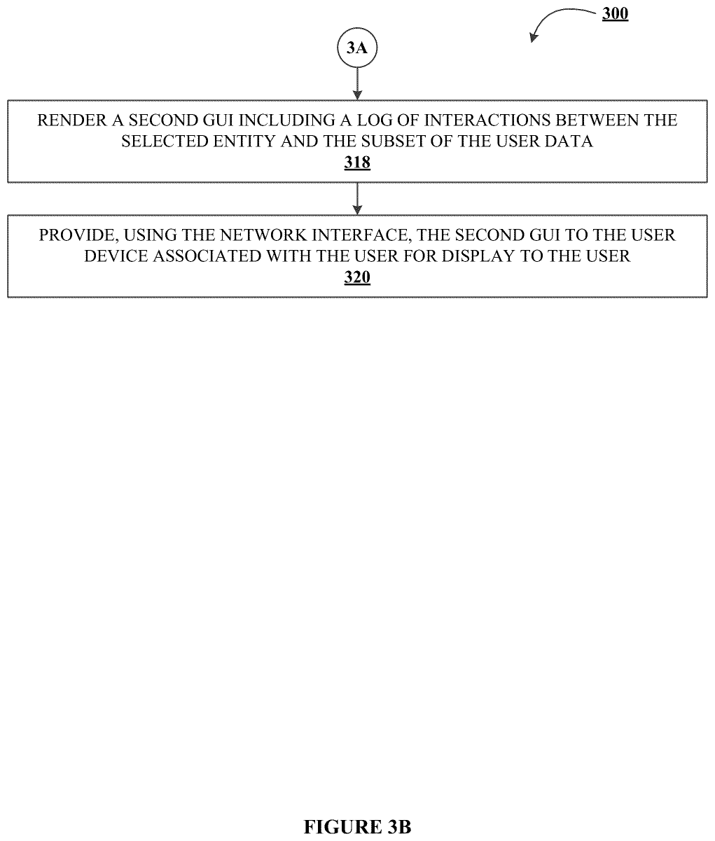

FIGS. 3A and 3B illustrate a process flow 300 for tracing used data by secondary entities, in accordance with an embodiment of the disclosure. In some embodiments, a system (e.g., similar to one or more of the systems shown and described herein with respect to FIGS. 1A-1C) may perform one or more of the steps of process flow 300. For example, a system for tracing used data by secondary entities (e.g., similar to the system 130 shown and described herein with respect to FIG. 1A-1C) may perform one or more of the steps of process flow 300. In some embodiments, an artificial intelligence engine (e.g., similar to the AI engine subsystem 200 as shown and described herein with respect to FIG. 2) may perform one or more of the steps of process flow 300.

As shown in block 302, the process flow 300 may include the step of receiving, using a network interface, user data associated with a user. In some embodiments, a user and/or a representative of the user (e.g., a caretaker, a steward, and/or the like) may choose to input data (e.g., enter data into a GUI associated with the system) associated with the user into the system. Further, the data may be transferred, via the network interface, into a memory location operatively coupled with the system.

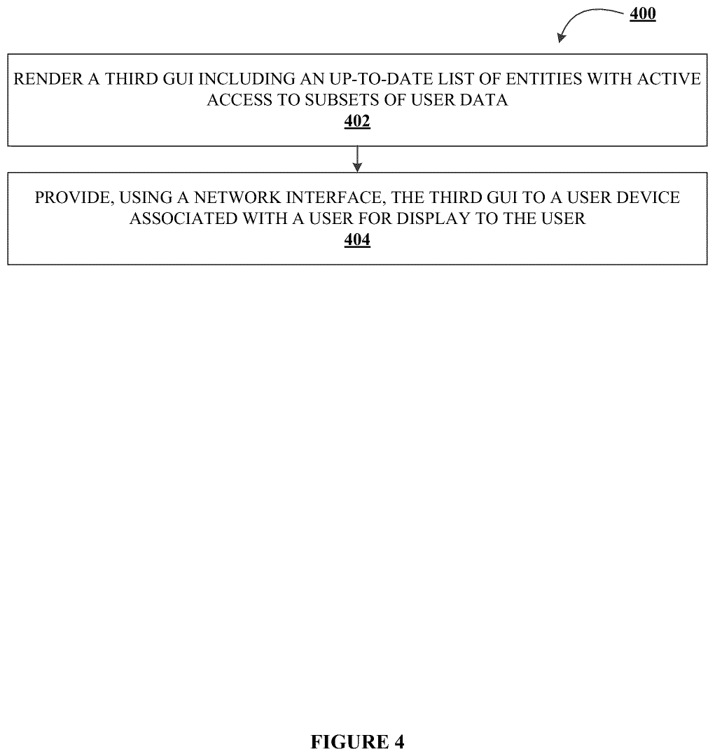

As shown in block 304, the process flow 300 may include the step of storing the user data on a distributed ledger. In some embodiments, the system may include the distributed ledger as a digital means of recording and storing user data for users associated with the system. Further, the distributed ledger may be configured to store non-user data that may be related to a user (e.g., data including entities that have permission to access data of a user and/or data as shown and described herein with respect to FIG. 4). Additionally, and/or alternatively, a user may store a subset of data associated with the user and/or may choose to not store data on the distributed ledger.

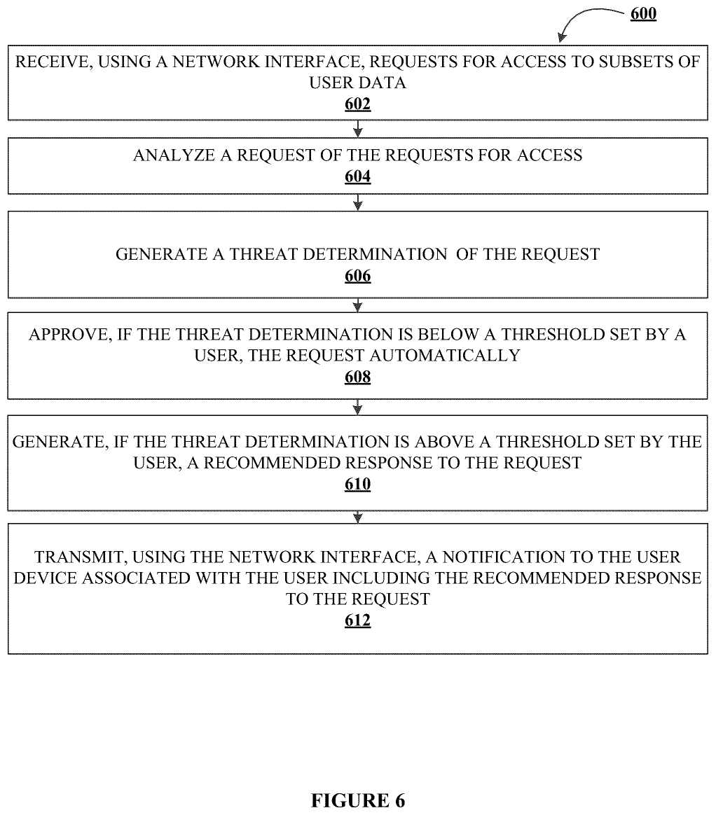

As shown in block 306, the process flow 300 may include the step of receiving, from a plurality of entities, requests for access to subsets of the user data. In some embodiments, an entity (e.g., a corporation, a company, a bank, an institution, a research group, an individual, and/or the like) of the plurality of entities may have a purpose for a subset of data associated with a user. Further, the entity may not have the ability to access (e.g., they are blocked from viewing and/or using the subset of user data) the subset of data. In such embodiments, the entity may input a request into the system, where the request may include the subset of data of the user the entity wants to access, the duration of access to the subset of user data, permissions to share the subset of user data with other entities, and/or the like. In some embodiments, the step of block 306 may be followed by some and/or all of the steps of process flow 600 as shown and described herein with respect to FIG. 6.

As shown in block 308, the process flow 300 may include the step of rendering a first graphical user interface (GUI) for receiving, from the user, input identifying permission levels for the plurality of entities to access the user data. In some embodiments, the system may, upon receiving a request for access to data from an entity, send a notification (e.g., an email, a test message, an alert, and/or the like) of the request to the user associated with the requested data. Further, upon receipt of the notification, the user may input a request to input identifying permission levels to the system. In such embodiments, the system may be configured to render the first GUI to transmit to the user to provide the input identifying permission levels. Additionally, and/or alternatively, if the user wants to deny access to the entity, the user may not input the request to input identifying permission levels to the system.

As shown in block 310, the process flow 300 may include the step of providing, using the network interface, the first GUI to a user device associated with the user for display to the user. In some embodiments, the system may, upon receiving the request to input identifying permission levels from the user, transmit, via the network interface, the rendered first GUI to the user device (e.g., a laptop computer, a desktop computer, a tablet device, a smart phone device, and/or the like) of the user. In such embodiments, the first GUI may include text describing what the entity is asking permission for, text describing permission level options, and/or interactive regions for the user to select a permission level.

As shown in block 312, the process flow 300 may include the step of receiving, from the user device and using the network interface, a selected permission level for an entity of the plurality of entities selected by the user using the first graphical user interface, where each entity of the plurality of entities has a different permission level or a same permission level. In some embodiments, after the user selects the permission level for the entity, the input may be transferred via the network interface. Further, the selected permission level for the subset of user data for the entity may be stored on the distributed ledger. Additionally, and/or alternatively, if the user does not select a permission level, the system may be configured to set a permission level that grants no access to the user data for the entity.

As shown in block 314, the process flow 300 may include the step of generating, using the network interface, a smart contract on the distributed ledger that permits devices with a token to access a subset of the user data. In some embodiments, a smart contract may include the selected permission levels for a subset of user data a user has chosen for an entity. Further, the smart contract may include details of the request for access the entity input (e.g., a duration of access, the subset of data accessible, permission to share access with other entities, and/or the like). Additionally, and/or alternatively, the smart contract may be stored on the distributed ledger indefinitely and/or for a set duration (e.g., the duration of access allowed by the selected permission level). In some embodiments, a record of the smart contract may be stored on the distributed ledger.

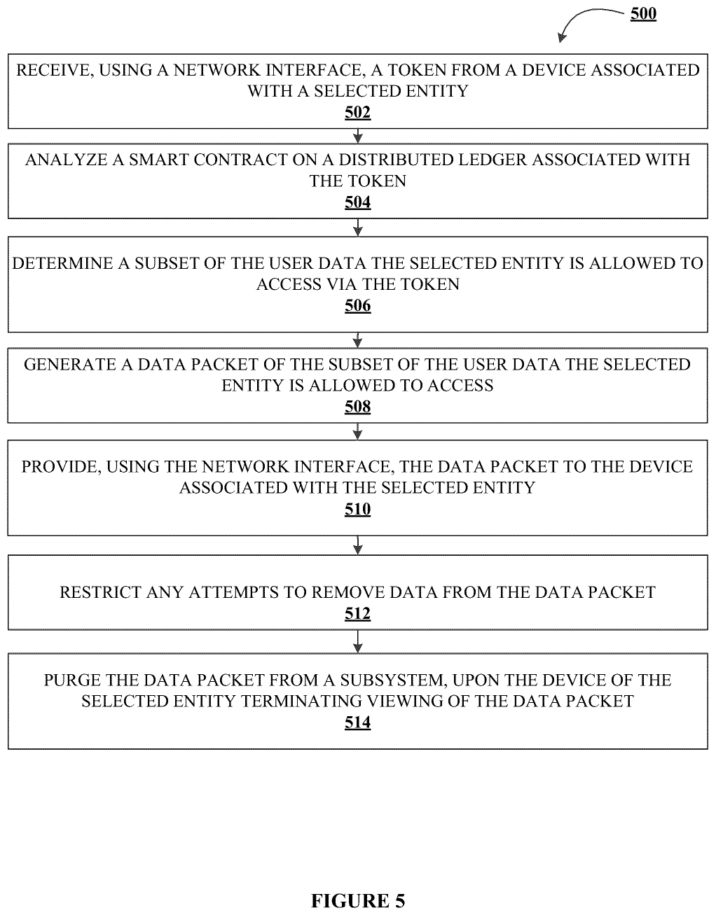

As shown in block 316, the process flow 300 may include the step of providing, using the network interface, the token to a device associated with the selected entity. In some embodiments, the smart contract may be configured to deny access to a subset of user data unless presented with the token (e.g., an authentication token, an authorization token, and/or the like) associated with the smart contract. Further, if the smart contract is presented with the token, the system may be configured to enable viewing, accessing, and/or the like, by the device presenting the token, of the subset of user data allowed by the smart contract. In some embodiments, if the smart contract is presented with the token, the system may be configured to follow the steps as shown and described herein with respect to FIG. 5.

As shown in block 318 of FIG. 3B, the process flow 300 may include the step of rendering a second GUI comprising a log of interactions between the selected entity and the subset of the user data. In some embodiments, the distributed ledger may be configured to store some and/or all of the interactions between the selected entity and/or other entities between the user and/or data of the user. Further, upon receipt of a request to view the log of interactions (e.g., a record of each interaction that has taken place between entities and a user), the second GUI may be rendered for transmission to the user for display on a device associated with the user.

As shown in block 320, the process flow 300 may include the step of providing, using the network interface, the second GUI to the user device associated with the user for display to the user. In some embodiments, the system may, upon receiving the request to view the log of interactions, transmit, via the network interface, the rendered second GUI to the user device (e.g., a laptop computer, a desktop computer, a tablet device, a smart phone device, and/or the like) of the user. In such embodiments, the second GUI may include text describing, for each interaction, who the entity is, what data the entity accessed, what date and/or time the data was accessed by the entity, and/or the like.

The process flow 300 may include additional embodiments, such as any single embodiment or any combination of embodiments described herein. Although FIGS. 3A and 3B show example blocks of the process flow 300, in some embodiments, the process flow 300 may include additional blocks, fewer blocks, different blocks, or differently arranged blocks than those depicted in FIGS. 3A and 3B. Additionally, or alternatively, two or more of the blocks of the process flow 300 may be performed in parallel.

FIG. 4 illustrates a process flow 400 for tracing used data by secondary entities, in accordance with an embodiment of the disclosure. In some embodiments, a system (e.g., similar to one or more of the systems shown and described herein with respect to FIGS. 1A-1C) may perform one or more of the steps of process flow 400. For example, a system for tracing used data by secondary entities (e.g., similar to the system 130 shown and described herein with respect to FIG. 1A-1C) may perform the steps of process flow 400. In some embodiments, an artificial intelligence engine (e.g., similar to the AI engine subsystem 200 as shown and described herein with respect to FIG. 2) may perform one or more of the steps of process flow 400.

In some embodiments, and as shown in block 402, the process flow 400 may include the step of rendering a third (GUI) including an up-to-date list of entities with active access to subsets of user data. In some embodiments, the distributed ledger may be configured to store some and/or all of the entities with active access to subsets of user data of a user. Further, upon receipt of a request to view the list, the system may be configured to render the third GUI for transmission to the user for display on a device associated with the user. Additionally, and/or alternatively, the list may include entities that had access to subsets of the user data in the past, but do not currently have access to the subsets of the user data.

In some embodiments, and as shown in block 404, the process flow 400 may include the step of providing, using the network interface, the third GUI to a user device associated with a user for display to the user. In some embodiments, the system may, upon receiving the request to view the list, transmit, via the network interface, the rendered third GUI to the user device (e.g., a laptop computer, a desktop computer, a tablet device, a smart phone device, and/or the like) of the user. In such embodiments, the third GUI may include text describing, for each entity with active access to subsets of user data, who the entity is, what subset of user data the entity has access to, what the duration of access to the subset of user data is, and/or the like. Additionally, and/or alternatively, for entities that had access to the subsets of user data in the past, but do not currently have access, the third GUI may include text describing who the entity is, what subset of user data the entity had access to, what the duration of access to the subset of user data was, and/or the like.

The process flow 400 may include additional embodiments, such as any single embodiment or any combination of embodiments described herein. Although FIG. 4 shows example blocks of the process flow 400, in some embodiments, the process flow 400 may include additional blocks, fewer blocks, different blocks, or differently arranged blocks than those depicted in FIG. 4. Additionally, or alternatively, two or more of the blocks of the process flow 400 may be performed in parallel.

FIG. 5 illustrates a process flow 500 for tracing used data by secondary entities, in accordance with an embodiment of the invention. In some embodiments, a system (e.g., similar to one or more of the systems shown and described herein with respect to FIGS. 1A-1C) may perform one or more of the steps of process flow 500. For example, a system for tracing used data by secondary entities (e.g., similar to the system 130 shown and described herein with respect to FIG. 1A-1C) may perform the steps of process flow 500. In some embodiments, an artificial intelligence engine (e.g., such as the AI engine subsystem 200 as shown and described herein with respect to FIG. 2) may perform one or more of the steps of process flow 500. In some embodiments, a subsystem operatively coupled to a distributed ledger (e.g., a system configured to encrypt data on a distributed ledger and/or control access to data on the distributed ledger) may perform one or more of the steps of process flow 500.

In some embodiments, and as shown in block 502, the process flow 500 may include the step of receiving, using a network interface, a token from a device associated with a selected entity. In some embodiments, the token may be associated with a smart contract that may include selected permission levels for a subset of user data a user has chosen for an entity. Further, the associated smart contract may include details of a request for access the entity input (e.g., a duration of access, the subset of data accessible, permission to share access with other entities, and/or the like). In such embodiments, a subsystem operatively coupled to a distributed ledger may be configured to receive the token from the device via the network interface. In some embodiments, the step of block 502 may follow after the step of block 316 as shown and described herein with respect to FIG. 3.

In some embodiments, the smart contract may be configured to deny access to a subset of user data unless presented with the token associated with the smart contract. Further, if the smart contract is presented with the token, the system (e.g., performing the process flow 500) may be configured to enable viewing, accessing, and/or the like, by the device presenting the token, of the subset of user data allowed by the smart contract.

In some embodiments, and as shown in block 504, the process flow 500 may include the step of analyzing a smart contract on a distributed ledger associated with the token. In some embodiments, the subsystem (e.g., performing the process flow 500) may be configured to decipher the token. For example, the token may include encoded information including information about the entity, a signature associated with the token (e.g., to ensure the token was correctly issued and/or the token was not modified without authorization), a duration of the token, information on a smart contract associated with the token, and/or the like. After receiving the token, the subsystem (e.g., performing the process flow 500) may extract the encoded information and decode the encoded information. In such embodiments, the subsystem (e.g., performing the process flow 500) may be configured to, if the signature encoded on the token is legitimate, validate the token and/or the device associated with the selected entity transmitting the token. Further, upon validation, the subsystem (e.g., performing the process flow 500) may analyze the decoded information to extract information on the associated smart contract (e.g., a hash of where the smart contract is stored on the distributed ledger).

In some embodiments, the subsystem (e.g., performing the process flow 500) may, using the decoded information, access the smart contract associated with the token. Further, the subsystem (e.g., performing the process flow 500) may analyze the smart contract for details including the user associated with the smart contract, a subset of user data associated with the smart contract (e.g., a hash of where on the distributed ledger the user data is stored and what data elements of the user data the smart contract grants permission for), a permission level associated with the smart contract, the duration of the smart contract, and/or the like.

In some embodiments, and as shown in block 506, the process flow 500 may include the step of determining a subset of user data the selected entity is allowed to access via the token. In some embodiments, the token may be associated with the smart contract that may include data on the subset of user data the selected entity has permission to access. Further, the subsystem (e.g., performing the process flow 500) may be configured, upon receipt of the token from the device associated with the selected entity, access the smart contract and extract information on the subset of user data from the smart contract. In such embodiments, the subsystem may access a memory location of the distributed ledger where the user data is stored and may extract the subset of the user data the smart contract grants access to for the selected entity.

In some embodiments, and as shown in block 508, the process flow 500 may include the step of generating a data packet of the subset of the user data the selected entity is allowed to access. In some embodiments, the subsystem may, after extracting the subset of user data from the distributed ledger, generate the data packet (e.g., elements of data for transmission) of the subset of user data for presentation to the selected entity.

In some embodiments, and as shown in block 510, the process flow 500 may include the step of providing, using the network interface, the data packet to the device associated with the selected entity. In some embodiments, the subsystem may transmit, via the network interface, the data packet including the subset of user data to the device of the selected entity. Further, the transmission may have a limited duration (e.g., based on constraints in the token). Additionally, or alternatively, the subsystem may be configured, during transmission, to cancel transmission if data packet misappropriation is detected (e.g., an authorized entity is attempting to gain access, data is attempting to be removed from the data packet, and/or the like).

In some embodiments, and as shown in block 512, the process flow 500 may include the step of restricting any attempts to remove data from the data packet. In some embodiments, the subsystem may transmit the data packet into a controlled environment for display on the device associated with the selected entity. In such embodiments, the subsystem may monitor the controlled environment for any occurrence of data misappropriation. For example, the subsystem may monitor the controlled environment and detect an attempt to extract data from the controlled environment. In such events, the subsystem may be configured to terminate transmission of the data packet. In some embodiments, the controlled environment may be configured to prevent actions that may extract data from the controlled environment (e.g., selecting data to copy and paste, screenshotting data, and/or the like).

In some embodiments, and as shown in block 514, the process flow 500 may include the step of purging the data packet from a subsystem, upon the device of the selected entity terminating viewing of the data packet. In some embodiments, once the selected entity has viewed the subset of user data and terminated viewing, the subsystem may be configured to prevent a build up of excess data packets and/or prevent increased threat of misappropriation by purging the data packet from the subsystem. Additionally, and/or alternatively, the subsystem may be configured to extract a duration of viewing from the token and, if viewing of the data packet has exceeded the duration, purge the data packet from the subsystem.

The process flow 500 may include additional embodiments, such as any single embodiment or any combination of embodiments described herein. Although FIG. 5 shows example blocks of the process flow 500, in some embodiments, the process flow 500 may include additional blocks, fewer blocks, different blocks, or differently arranged blocks than those depicted in FIG. 5. Additionally, or alternatively, two or more of the blocks of the process flow 500 may be performed in parallel.

FIG. 6 illustrates a process flow 600 for tracing used data by secondary entities, in accordance with an embodiment of the invention. In some embodiments, a system (e.g., similar to one or more of the systems shown and described herein with respect to FIGS. 1A-1C) may perform one or more of the steps of process flow 600. For example, a system for tracing used data by secondary entities (e.g., similar to the system 130 shown and described herein with respect to FIG. 1A-1C) may perform the steps of process flow 600. In some embodiments, an artificial intelligence engine (e.g., such as the AI engine subsystem 200 as shown and described herein with respect to FIG. 2) may perform one or more of the steps of process flow 600.

In some embodiments, and as shown in block 602, the process flow 600 may include the step of receiving, using a network interface, requests for access to subsets of user data. In some embodiments, an AI model may be configured to receive the requests for access to subsets of user data prior to a user receiving a request for access to the data associated with the user. In such embodiments, a user may opt into permitting the AI model to monitor requests for access to data associated with the user or the user may opt out of permitting the AI model to monitor requests for access to data associated with the user. Further, the AI model may not be able to access user data from the distributed ledger. In some embodiments, the step of block 602 may be preceded by the step of block 306 as shown and described herein with respect to FIG. 3.

In some embodiments, and as shown in block 604, the process flow 600 may include the step of analyzing a request of the requests for access. In some embodiments, the request for access may include a name of an entity requesting access, a duration of access, the subset of data accessible, permission to share access with other entities, and/or the like. In such embodiments, the AI model may be configured to extract data from the request and analyze the data (e.g., assign a threat metric to a data element of the data of the request). For example, the AI model may extract data from the request associated with what subset of user data the entity is requesting permission for. In such examples, if the subset of user data the request is asking permission to access includes personal identification information of a user, the AI model may be configured to assign an elevated threat metric to the data element versus if the subset of user data the request is asking permission to access only included transactional data of the user. In some embodiments, the AI model may be configured to store some of and/or all of the data of the request for use in analysis of other requests. For example, the AI model may store data on the number of requests sent by an entity for a specific subset of user data to users. In such examples, if the AI model determines the volume of requests sent by the entity for a specific subset of user data to users is abnormal, the AI model may assign an elevated threat metric to the data element versus if the volume of requests is in a normal range.

In some embodiments, and as shown in block 606, the process flow 600 may include the step of generating a threat determination of the request. In some embodiments, after the AI model has analyzed each data element of the data of the request, the AI model may be configured to generate a threat determination of the requests including an overall evaluation of threat (e.g., threat metrics for each data element may be multiplied by a weighted coefficient (e.g., weights determined by the AI model and/or the developers of the AI model that denote the contribution an element makes to the calculation) and used in a normalized sum and/or another form of calculation to determine the overall threat of the request). Further, the threat determination of the request may include the threat metric of each data element and/or an AI generated summary for each data element including the reasons behind the assigned threat metric.

In some embodiments, and as shown in block 608, the process flow 600 may include the step of approving, if the threat determination is below a threshold set by a user, the request automatically. In some embodiments, if a user opts into using the AI model, the opt-in process may include an option to select a threshold of threat below which a request may be automatically approved by the AI model. In such embodiments, the AI model may be configured to transmit a notification to a device associated with a user a request is for that the request was approved automatically. Further, the notification may include an option to overturn the approval of the AI and reject the request within a set period of time. Additionally, and/or alternatively, a user may change the threshold of threat. In some embodiments, the step of block 608 may be followed by the step of block 314 as shown and described herein with respect to FIG. 3.

In some embodiments, and as shown in block 610, the process flow 600 may include the step of generating, if the threat determination is above a threshold set by the user, a recommended response to the request. In some embodiments, the AI model may be configured to generate a summary of what the AI has determined the threat level of the request to be. Further, the recommended response may include the threat determination generated by the AI model. In some embodiments, if the threat determination is above the threshold set by the user, the AI model may recommend the user accept the request. In some embodiments, if the threat determination is above the threshold set by the user, the AI model may recommend the user does not accept the request. In some embodiments, if the threat determination is above the threshold set by the user, the AI model may recommend a new set of terms to the user to transmit to the entity requesting access to data associated with the user.

In some embodiments, and as shown in block 612, the process flow 600 may include the step of transmitting, using the network interface, a notification to the user device associated with the user including the recommended response to the request. In some embodiments, once the AI model has finalized the evaluation of the request, the AI model may be configured to notify the user via a notification of the determination to and/or recommended response of the request. Further, the notification may include a text message, an email, an alert, and/or the like. In some embodiments, the step of block 612 may be followed by the step of block 310 as shown and described herein with respect to FIG. 3.

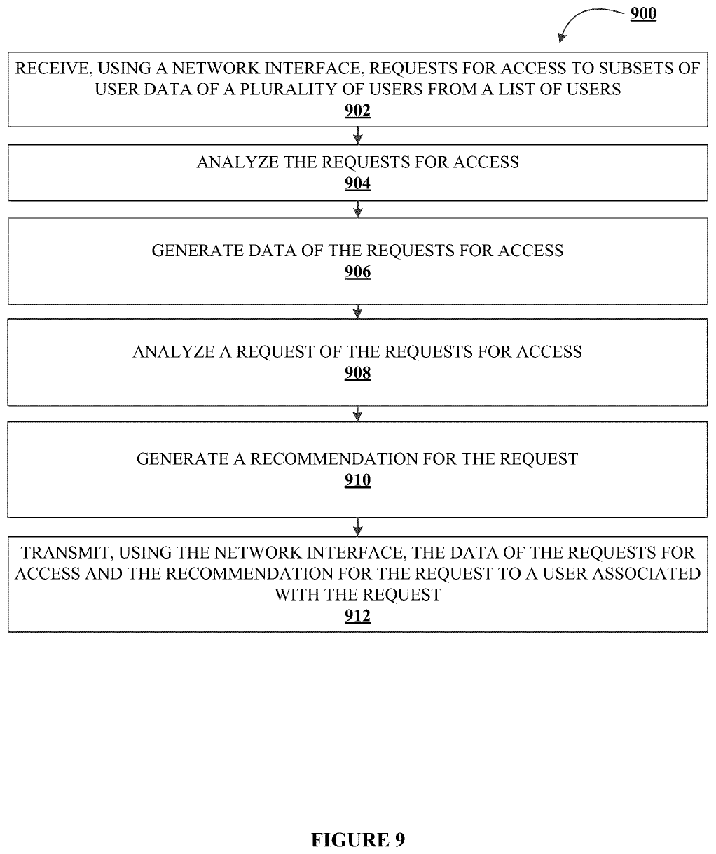

The process flow 600 may include additional embodiments, such as any single embodiment or any combination of embodiments described herein. Although FIG. 6 shows example blocks of the process flow 600, in some embodiments, the process flow 600 may include additional blocks, fewer blocks, different blocks, or differently arranged blocks than those depicted in FIG. 6. Additionally, or alternatively, two or more of the blocks of the process flow 600 may be performed in parallel. In some embodiments, some and/or all of the steps of process flow 600 may occur before, after, and/or concurrently with the steps of process flow 900 as shown and described herein with respect to FIG. 9.

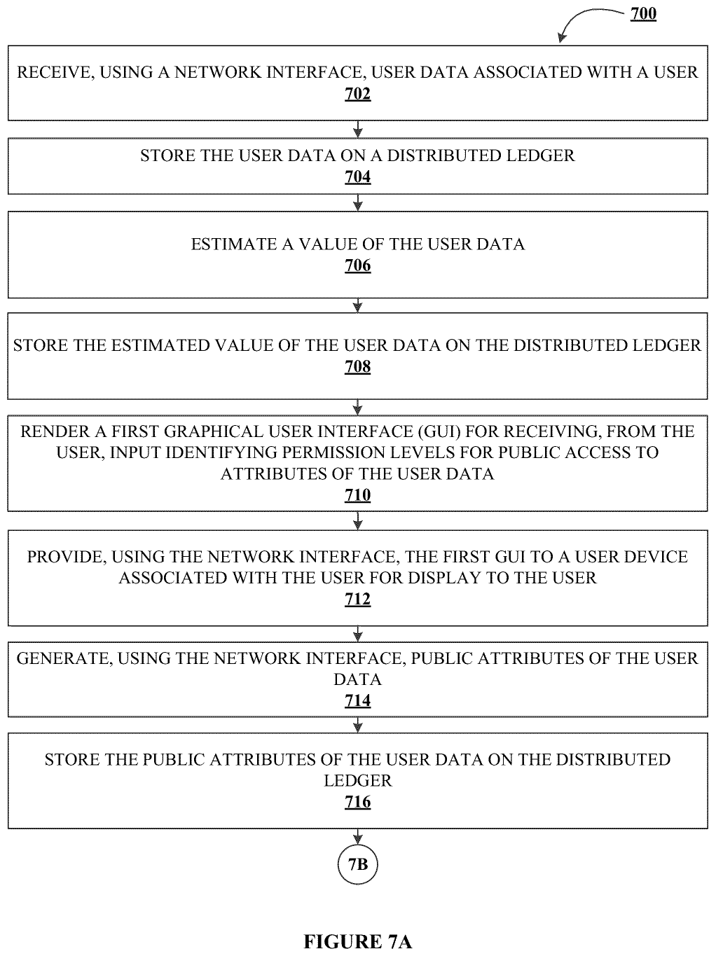

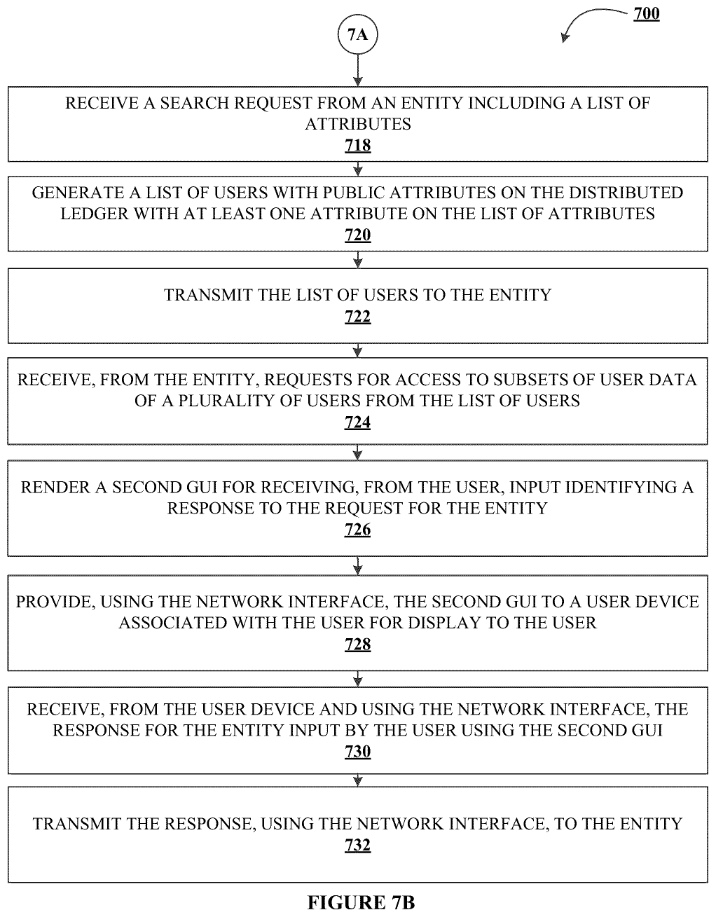

FIGS. 7A and 7B illustrate a process flow 700 for tracking access to user data, in accordance with an embodiment of the invention. In some embodiments, a system (e.g., similar to one or more of the systems shown and described herein with respect to FIGS. 1A-1C) may perform one or more of the steps of process flow 700. For example, a system for tracking access to user data (e.g., similar to the system 130 shown and described herein with respect to FIG. 1A-1C) may perform the steps of process flow 700. In some embodiments, an artificial intelligence engine (e.g., such as the AI engine subsystem 200 as shown and described herein with respect to FIG. 2) may perform one or more of the steps of process flow 700. In some embodiments, the system performing one or more of the steps of process flow 300 may be configured to perform one or more of the steps of process flow 700.

In some embodiments, and as shown in block 702, the process flow 700 may include the step of receiving, using a network interface, user data associated with a user. In some embodiments, a user and/or a representative of the user (e.g., a caretaker, a steward, and/or the like) may choose to input data (e.g., enter data into a GUI associated with the system) associated with the user into the system. Further, the data may be transferred, via the network interface, into a memory location operatively coupled with the system.

In some embodiments, and as shown in block 704, the process flow 700 may include the step of storing the user data on a distributed ledger. In some embodiments, the system may include the distributed ledger as a digital means of recording and storing user data for users associated with the system. Further. the distributed ledger may be configured to store non-user data that may be related to a user (e.g., data including entities that have permission to access data of a user and/or data as shown and described herein with respect to FIG. 4). Additionally, and/or alternatively, a user may store a subset of data associated with the user and/or may choose to not store data on the distributed ledger.

In some embodiments, and as shown in block 706, the process flow 700 may include the step of estimating a value of the user data. In some embodiments, entities may have an interest in paying for access to user data for a purpose associated with an entity. In such embodiments, based on demand for user data, demand for user data with specific attributes, demand for user data for specific purposes, and/or the like, a value may be assigned to data associated with a user. Further, each data element of the user data may be assigned an individual value. Additionally, and/or alternatively, the value may be fixed and/or may fluctuate on a temporal basis.

In some embodiments, and as shown in block 708, the process flow 700 may include the step of storing the estimated value of the user data on the distributed ledger. In some embodiments, the estimated value may be assigned a location on the distributed ledger for permanent and/or temporary storage. Further, the estimated value may be stored along with a link (e.g., a hash) to the location of the user data the estimated value is associated with.

In some embodiments, and as shown in block 710, the process flow 700 may include the step of rendering a first graphical user interface (GUI) for receiving, from the user, input identifying permission levels for public access to attributes of the user data. In some embodiments, the user may input a request to publicly display attributes of the data associated with the user (e.g., data elements of user data that entities may search for to request access for user data of users with one or more of those data elements). Further, upon receiving the request, the first GUI may be generated and transmitted to the user for inputting permission levels for attributes the user wants to make publicly available.

In some embodiments, and as shown in block 712, the process flow 700 may include the step of providing, using the network interface, the first GUI to a user device associated with the user for display to the user. In some embodiments, the system may, upon receiving the request to input permissions levels for public access to attributes of user data from the user, transmit, via the network interface, the rendered first GUI to the user device (e.g., a laptop computer, a desktop computer, a tablet device, a smart phone device, and/or the like) of the user. In such embodiments, the first GUI may include text describing what each attribute is, text describing permission level options for attributes, and/or interactive regions for the user to select a permission level for an attribute.

In some embodiments, and as shown in block 714, the process flow 700 may include the step of generating, using the network interface, public attributes of the user data. In some embodiments, the system may receive the input permission levels for public access to attributes of user data from the user. Further, upon receipt of the input, the attributes denoted by the user to be public may be generated in a public form for public access. For example, if a type of biometric data is searched for on the distributed ledger, if a user has this attribute and made this attribute public, the user may appear in the search.

In some embodiments, and as shown in block 716, the process flow 700 may include the step of storing the public attributes of the user data on the distributed ledger. In some embodiments, the distributed ledger may be configured to store what attributes are publicly accessible. Further, an entity may be able to, without requiring authorization, view the attributes that are publicly accessible on the distributed ledger.

In some embodiments, and as shown in block 718 of FIG. 7B, the process flow 700 may include the step of receiving a search request from an entity including a list of attributes. In some embodiments, the system may be configured to provide an interactable environment for inputting search requests directed to finding users with public attributes fitting the parameters of the search request. Further, the interactable environment may include additional interactable features for including constraints in the search parameters.

In some embodiments, and as shown in block 720, the process flow 700 may include the step of generating a list of users with public attributes on the distributed ledger with at least one attribute on the list of attributes. In some embodiments, upon receiving the search request from the entity, the system may begin searching and/or selecting users with public attributes that match the parameters of the search request. Further, after the system has identified a user to fall within the search parameters, the user may be added to the list. In some embodiments, adding a user to the list may include adding a link (e.g., a hash) to a memory location of the data associated with the user on the distributed ledger.

In some embodiments, and as shown in block 722, the process flow 700 may include the step of transmitting the list of users to the entity. In some embodiments, after the user search has been exhausted, the completed list of users matching the selected parameters may be transmitted to a device associated with the entity. Additionally, and/or alternatively, a response indicating no matches were found may be sent to the device associated with an entity in the event the search did not yield a match. Further, a notification of invalid input may be transmitted to the device associated with the entity in the event the entity has added an invalid input to an interactive region of the first GUI.

In some embodiments, and as shown in block 724, the process flow 700 may include the step of receiving, from the entity, requests for access to subsets of user data of a plurality of users from the list of users. In some embodiments, the entity (e.g., a corporation, a company, a bank, an institution, a research group, an individual, and/or the like) may have a purpose for a subset of data associated with a user. Further, the entity may not have the ability to access (e.g., they are blocked from viewing and/or using the subset of user data) the subset of data. In such embodiments, the entity may input a request into the system, where the request may include the subset of data of the user the entity wants to access, the duration of access to the subset of user data, permissions to share the subset of user data with other entities, and/or the like. In some embodiments, the step of block 724 may be followed by some and/or all of the steps of process flow 600 as shown and described herein with respect to FIG. 6. Additionally, and/or alternatively, the step of block 724 may be followed by some and/or all of the steps of process flow 900 as shown and described herein with respect to FIG. 9.

In some embodiments, and as shown in block 726, the process flow 700 may include the step of rendering a second GUI for receiving, from the user, input identifying a response to the request for the entity. In some embodiments, the system may, upon receiving a request for access to data from an entity, send a notification (e.g., an email, a test message, an alert, and/or the like) of the request to the user associated with the requested data. Further, upon receipt of the notification, the user may input a request to respond to the request to the system. In such embodiments, the system may be configured to render the second GUI to transmit to the user to provide the input identifying the response. Additionally, and/or alternatively, if the user wants to deny access to the entity, the user may not input the response. In some embodiments, the step of block 726 may be preceded by the step of block 912 as shown and described herein with respect to FIG. 9. In some embodiments, the step of block 726 may be preceded by the step of block 612 as shown and described herein with respect to FIG. 6.

In some embodiments, and as shown in block 728, the process flow 700 may include the step of providing, using the network interface, the second GUI to a user device associated with the user for display to the user. In some embodiments, the system may, upon receiving the request to input the response from the user, transmit, via the network interface, the rendered second GUI to the user device (e.g., a laptop computer, a desktop computer, a tablet device, a smart phone device, and/or the like) of the user. In such embodiments, the second GUI may include text describing what the entity is asking permission for, text describing permission level options, what resource the entity is willing to exchange for data access, and/or interactive regions for the user to input a response to the request.

In some embodiments, and as shown in block 730, the process flow 700 may include the step of receiving, from the user device and using the network interface, the response for the entity input by the user using the second GUI. In some embodiments, after the user finishes inputting the response, the input may be transferred via the network interface. Further, the response for the entity may be stored on the distributed ledger temporarily and/or permanently. Additionally, and/or alternatively, if the user does not submit a response, the system may be configured to deny access to the user data to the entity.

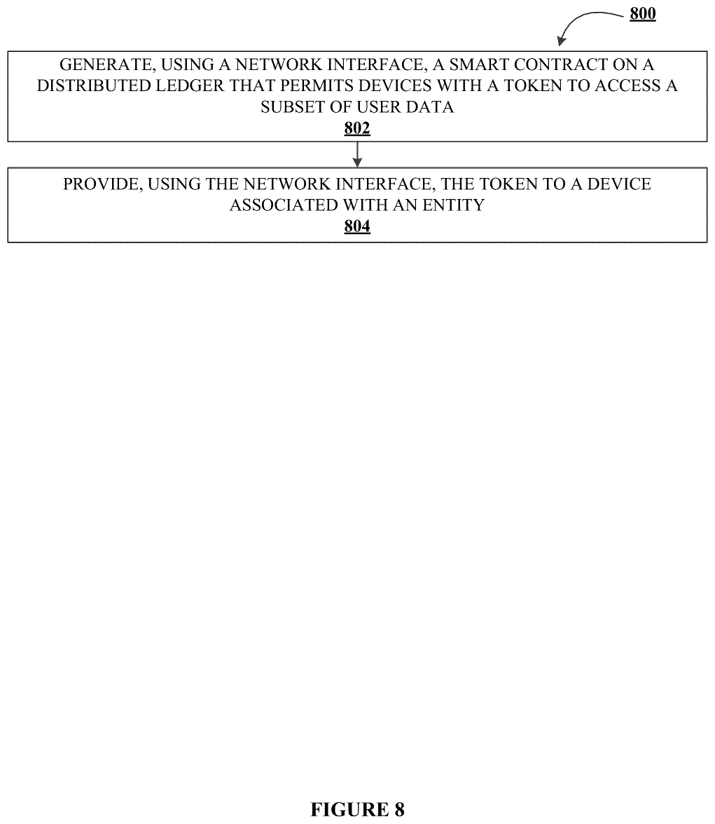

In some embodiments, and as shown in block 732, the process flow 700 may include the step of transmitting the response, using the network interface, to the entity. In some embodiments, the response may include an agreement to the request, a rejection of the request, and/or an amendment to terms of the request. In such embodiments, if the response includes an agreement to the request, the step of block 732 may be followed by the process flow 800 as shown and described herein with respect to FIG. 8.

The process flow 700 may include additional embodiments, such as any single embodiment or any combination of embodiments described herein. Although FIGS. 7A and 7B shows example blocks of the process flow 700, in some embodiments, the process flow 700 may include additional blocks, fewer blocks, different blocks, or differently arranged blocks than those depicted in FIGS. 7A and 7B. Additionally, or alternatively, two or more of the blocks of the process flow 700 may be performed in parallel.

FIG. 8 illustrates a process flow 800 for tracking access to user data, in accordance with an embodiment of the invention. In some embodiments, a system (e.g., similar to one or more of the systems shown and described herein with respect to FIGS. 1A-1C) may perform one or more of the steps of process flow 800. For example, a system for tracking access to user data (e.g., similar to the system 130 shown and described herein with respect to FIG. 1A-1C) may perform the steps of process flow 800. In some embodiments, an artificial intelligence engine (e.g., such as the AI engine subsystem 200 as shown and described herein with respect to FIG. 2) may perform one or more of the steps of process flow 800.

In some embodiments, and as shown in block 802, the process flow 800 may include the step of generating, using a network interface, a smart contract on a distributed ledger that permits devices with a token to access a subset of user data. In some embodiments, a smart contract may include the selected permission levels for a subset of user data a user has chosen for an entity. Further, the smart contract may include details of the request for access the entity input (e.g., a duration of access, the subset of data accessible, permission to share access with other entities, and/or the like). Additionally, and/or alternatively, the smart contract may be stored on the distributed ledger indefinitely and/or for a set duration (e.g., the duration of access allowed by the selected permission level). In some embodiments, a record of the smart contract may be stored on the distributed ledger. In some embodiments, the step of block 802 may be preceded by the step of block 732 as shown and described herein with respect to FIG. 7.

In some embodiments, and as shown in block 804, the process flow 800 may include the step of providing, using the network interface, the token to a device associated with an entity. In some embodiments, the smart contract may be configured to deny access to a subset of user data unless presented with the token (e.g., an authentication token, an authorization token, and/or the like) associated with the smart contract. Further, if the smart contract is presented with the token, the system may be configured to enable viewing, by the device presenting the token, of the subset of user data allowed by the smart contract. In some embodiments, if the smart contract is presented with the token, the system may be configured to follow the steps of process flow 500 as shown and described herein with respect to FIG. 5.

The process flow 800 may include additional embodiments, such as any single embodiment or any combination of embodiments described herein. Although FIG. 8 shows example blocks of the process flow 800, in some embodiments, the process flow 800 may include additional blocks, fewer blocks, different blocks, or differently arranged blocks than those depicted in FIG. 8. Additionally, or alternatively, two or more of the blocks of the process flow 800 may be performed in parallel.

FIG. 9 illustrates a process flow 900 for tracking access to user data, in accordance with an embodiment of the invention. In some embodiments, a system (e.g., similar to one or more of the systems shown and described herein with respect to FIGS. 1A-1C) may perform one or more of the steps of process flow 900. For example, a system for tracking access to user data (e.g., similar to the system 130 shown and described herein with respect to FIG. 1A-1C) may perform the steps of process flow 900. In some embodiments, an artificial intelligence engine (e.g., such as the AI engine subsystem 200 as shown and described herein with respect to FIG. 2) may perform one or more of the steps of process flow 900.

In some embodiments, and as shown in block 902, the process flow 900 may include the step of receiving, using a network interface, requests for access to subsets of user data of a plurality of users from a list of users. In some embodiments, a request for access may include a subset of user data the entity is allowed to access, a duration of allowed use of the subset of the user data, restrictions on the allowed use of the subset of the user data, permissions regarding the entity distributing access to the subset of the user data to other entities, an offer of resources provided by the entity for access to the subset of the user data, and/or the like. Additionally, and/or alternatively, an AI model may be configured to receive the requests for access to subsets of user data of a plurality of users prior to the users receiving the requests for access to the data associated with each user of the plurality of users. In such embodiments, a user may opt into permitting the AI model to analyze requests for access to subsets of data associated with the user or the user may opt out of permitting the AI model to analyze requests for access to subsets of data associated with the user. Further, the AI model may not be able to access user data from the distributed ledger. In some embodiments, the step of block 902 may be preceded by the step of block 724 as show and described herein with respect to FIG. 7.

In some embodiments, and as shown in block 904, the process flow 900 may include the step of analyzing the requests for access. In some embodiments, the AI model may be configured to extract data from each request and analyze the extracted data. In such embodiments, the analysis may include evaluating who the entity may be, the type of user data the entity may be searching for, the proposed use for the user data by the entity, and/or the like.

In some embodiments, and as shown in block 906, the process flow 900 may include the step of generating data of the requests for access. In some embodiments, the AI model may be configured to store some of and/or all of the data of the request for use in evaluating requests. For example, the AI model may store data on the number of requests sent by an entity for a set of attributes. In such examples, if the AI model determines the volume of requests sent by the entity for the set of attributes to users is elevated, the AI model may assign an increased resource weight versus if the volume of requests is in a normal range and/or lower range.

In some embodiments, and as shown in block 908, the process flow 900 may include the step of analyzing a request of the requests for access. In some embodiments, the request for access may include a name of an entity requesting access, a duration of access, the subset of data accessible, permission to share access with other entities, an offer of resources, and/or the like. In such embodiments, the AI model may be configured to extract data from the request and analyze the data (e.g., assign a resource weight to a data element of the data of the request). For example, the AI model may extract data from the request associated with what subset of user data the entity is requesting permission for. In such examples, if the subset of user data the request is asking permission to access includes personal identification information of a user, the AI model may be configured to assign an increased resource weight to the data element versus if the subset of user data the request is asking permission to access only included transactional data of the user.

In some embodiments, and as shown in block 910, the process flow 900 may include the step of generating a recommendation for the request. In some embodiments, after the AI model has analyzed each data element of the data of the request, the AI model may be configured to generate a recommendation for the request including an overall evaluation of estimated resource value of the requested user data (e.g., resource weights for each data element input into a calculation to estimate a resource value). Further, the recommendation to the request may include the resource weight of each data element and/or an AI generated summary for each data element including the reasons behind the assigned resource weight.

In some embodiments, the AI model may be configured to generate a summary of what the AI model has determined the recommendation to the request to be. Additionally, and/or alternatively, if the resource value is below the offer of resources in the request, the AI model may recommend the user accept the request. In some embodiments, if the resource value is above the offer of resources in the request, the AI model may recommend the user does not accept the request. In some embodiments, if the resource value is above the offer of resources in the request, the AI model may recommend a new set of terms to the user to transmit to the entity requesting access to data associated with the user.

In some embodiments, and as shown in block 912, the process flow 900 may include the step of transmitting, using the network interface, the data of the requests for access and the recommendation for the request to a user associated with the request. In some embodiments, once the AI model has finalized the evaluation of the request, the AI model may be configured to notify the user via a notification of the determination to and/or recommended response of the request along with the data of the request. Further, the notification may include a text message, an email, an alert, and/or the like. In some embodiments, the step of block 912 may be followed by the step of block 726 as shown and described herein with respect to FIG. 7.

The process flow 900 may include additional embodiments, such as any single embodiment or any combination of embodiments described herein. Although FIG. 9 shows example blocks of the process flow 900, in some embodiments, the process flow 900 may include additional blocks, fewer blocks, different blocks, or differently arranged blocks than those depicted in FIG. 9. Additionally, or alternatively, two or more of the blocks of the process flow 900 may be performed in parallel. In some embodiments, some and/or all of the steps of process flow 900 may occur before, after, and/or concurrently with the steps of process flow 600 as shown and described herein with respect to FIG. 6.

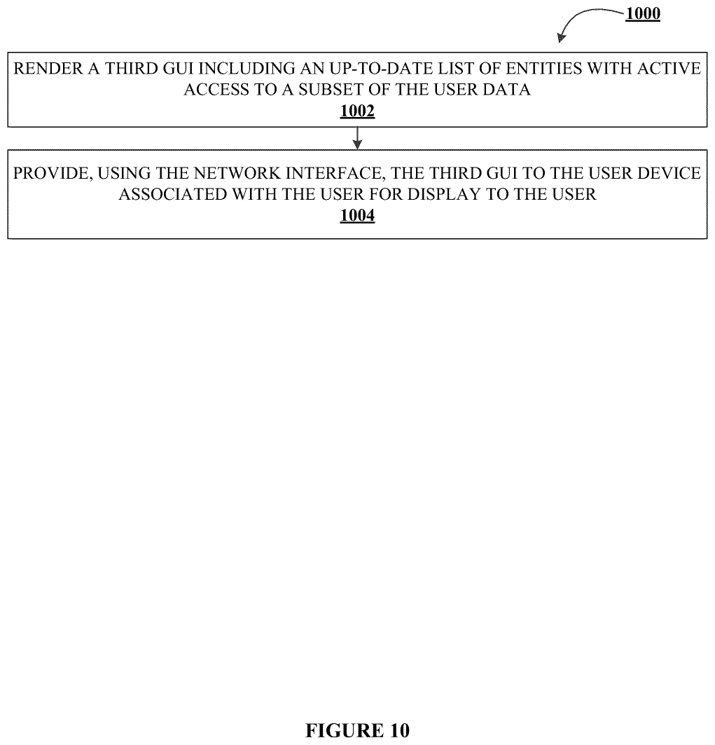

FIG. 10 illustrates a process flow 1000 for tracking access to user data, in accordance with an embodiment of the invention. In some embodiments, a system (e.g., similar to one or more of the systems shown and described herein with respect to FIGS. 1A-1C) may perform one or more of the steps of process flow 1000. For example, a system for tracking access to user data (e.g., similar to the system 130 shown and described herein with respect to FIG. 1A-1C) may perform the steps of process flow 1000. In some embodiments, an artificial intelligence engine (e.g., such as the AI engine subsystem 200 as shown and described herein with respect to FIG. 2) may perform one or more of the steps of process flow 1000.

In some embodiments, and as shown in block 1002, the process flow 1000 may include the step of rendering a third GUI including an up-to-date list of entities with active access to a subset of the user data. In some embodiments, the distributed ledger may be configured to store some and/or all of the entities with active access to subsets of user data of a user. Further, upon receipt of a request to view the list, the system may be configured to render the third GUI for transmission to the user for display on a device associated with the user. Additionally, and/or alternatively, the list may include entities that had access to subsets of the user data in the past, but do not currently have access to the subsets of the user data.

In some embodiments, and as shown in block 1004, the process flow 1000 may include the step of providing, using the network interface, the third GUI to the user device associated with the user for display to the user. In some embodiments, the system may, upon receiving the request to view the list, transmit, via the network interface, the rendered third GUI to the user device (e.g., a laptop computer, a desktop computer, a tablet device, a smart phone device, and/or the like) of the user. In such embodiments, the third GUI may include text describing, for each entity with active access to subsets of user data, who the entity is, what subset of user data the entity has access to, what the duration of access to the subset of user data is, and/or the like. Additionally, and/or alternatively, for entities that had access to the subsets of user data in the past, but do not currently have access, the third GUI may include text describing who the entity is, what subset of user data the entity had access to, what the duration of access to the subset of user data was, and/or the like.

The process flow 1000 may include additional embodiments, such as any single embodiment or any combination of embodiments described herein. Although FIG. 10 shows example blocks of the process flow 1000, in some embodiments, the process flow 1000 may include additional blocks, fewer blocks, different blocks, or differently arranged blocks than those depicted in FIG. 10. Additionally, or alternatively, two or more of the blocks of the process flow 1000 may be performed in parallel.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for tracking access to user data, the system comprising:
a network interface configured to communicate via a communication network;
a non-transitory storage device comprising computer program code stored thereon; and
a processing device operably coupled to the network interface, and the non-transitory storage device, wherein the computer program code comprises computer instructions configured to cause the processing device to:
receive, using the network interface, user data associated with a user;
store the user data on a distributed ledger;
estimate a value of the user data;
store the estimated value of the user data on the distributed ledger;
render a first graphical user interface (GUI) for receiving, from the user, input identifying permission levels for public access to attributes of the user data;
provide, using the network interface, the first GUI to a user device associated with the user for display to the user;
generate, using the network interface, public attributes of the user data;
store the public attributes of the user data on the distributed ledger;
receive a search request from an entity comprising a list of attributes;
generate a list of users with public attributes on the distributed ledger with at least one attribute on the list of attributes;
transmit the list of users to the entity;
receive, from the entity, requests for access to subsets of user data of a plurality of users from the list of users;
render a second GUI for receiving, from the user, input identifying a response to the request for the entity;
provide, using the network interface, the second GUI to a user device associated with the user for display to the user;
receive, from the user device and using the network interface, the response for the entity input by the user using the second GUI; and
transmit the response, using the network interface, to the entity.

2. The system of claim 1, wherein each request for access of the requests for access from the entity to the plurality of users comprises:
a subset of user data the entity is allowed to access;
a duration of allowed use of the subset of the user data;
restrictions on the allowed use of the subset of the user data;
permissions regarding the entity distributing access to the subset of the user data to other entities; and
an offer of resources provided by the entity for access to the subset of the user data.

3. The system of claim 2, wherein the response to the request comprises an agreement to the request, a rejection of the request, or an amendment to terms of the request.

4. The system of claim 3, wherein the computer program code comprises computer instructions configured to cause the processing device to, if the response comprises an agreement:
generate, using the network interface, a smart contract on the distributed ledger that permits devices with a token to access the subset of the user data; and
provide, using the network interface, the token to a device associated with the entity.

5. The system of claim 2, comprising a generative AI model configured to:
receive, using the network interface, the requests for access to subsets of user data of the plurality of users from the list of users;
analyze the requests for access;
generate data of the requests for access;
analyze a request of the requests for access;
generate a recommendation for the request; and
transmit, using the network interface, the data of the requests for access and the recommendation for the request to a user associated with the request.

6. The system of claim 5, wherein the generative AI model is configured to translate a name of an entity into a user-friendly form.

7. The system of claim 1, wherein the system is configured to:
render a third GUI comprising an up-to-date list of entities with active access to a subset of the user data; and
provide, using the network interface, the third GUI to the user device associated with the user for display to the user.

8. A computer program product for tracking access to user data, the computer program product comprising a non-transitory computer-readable medium comprising code causing an apparatus to:
receive, using a network interface, user data associated with a user;
store the user data on a distributed ledger;
estimate a value of the user data;
store the estimated value of the user data on the distributed ledger;
render a first graphical user interface (GUI) for receiving, from the user, input identifying permission levels for public access to attributes of the user data;
provide, using the network interface, the first GUI to a user device associated with the user for display to the user;
generate, using the network interface, public attributes of the user data;
store the public attributes of the user data on the distributed ledger;
receive a search request from an entity comprising a list of attributes;
generate a list of users with public attributes on the distributed ledger with at least one attribute on the list of attributes;
transmit the list of users to the entity;
receive, from the entity, requests for access to subsets of user data of a plurality of users from the list of users;
render a second GUI for receiving, from the user, input identifying a response to the request for the entity;
provide, using the network interface, the second GUI to a user device associated with the user for display to the user;
receive, from the user device and using the network interface, the response for the entity input by the user using the second GUI; and
transmit the response, using the network interface, to the entity.

9. The computer program product of claim 8, wherein each request for access of the requests for access from the entity to the plurality of users comprises:
a subset of user data the entity is allowed to access;
a duration of allowed use of the subset of the user data;
restrictions on the allowed use of the subset of the user data;
permissions regarding the entity distributing access to the subset of the user data to other entities; and
an offer of resources provided by the entity for access to the subset of the user data.

10. The computer program product of claim 9, wherein the response to the request comprises an agreement to the request, a rejection of the request, or an amendment to terms of the request.

11. The computer program product of claim 10, wherein the computer program product comprises computer instructions configured to, if the response comprises an agreement:
generate, using the network interface, a smart contract on the distributed ledger that permits devices with a token to access the subset of the user data; and
provide, using the network interface, the token to a device associated with the entity.

12. The computer program product of claim 9, comprising a generative AI model configured to:
receive, using the network interface, the requests for access to subsets of user data of the plurality of users from the list of users;
analyze the requests for access;
generate data of the requests for access;
analyze a request of the requests for access;
generate a recommendation for the request; and
transmit, using the network interface, the data of the requests for access and the recommendation for the request to a user associated with the request.

13. The computer program product of claim 12, wherein the generative AI model is configured to translate a name of an entity into a user-friendly form.

14. The computer program product of claim 8, wherein the computer program product is configured to:
render a third GUI comprising an up-to-date list of entities with active access to a subset of the user data; and
provide, using the network interface, the third GUI to the user device associated with the user for display to the user.

15. A method for tracking access to user data, the method comprising:
receiving, using a network interface, user data associated with a user;
storing the user data on a distributed ledger;
estimating a value of the user data;
storing the estimated value of the user data on the distributed ledger;
rendering a first graphical user interface (GUI) for receiving, from the user, input identifying permission levels for public access to attributes of the user data;
providing, using the network interface, the first GUI to a user device associated with the user for display to the user;
generating, using the network interface, public attributes of the user data;
storing the public attributes of the user data on the distributed ledger;
receiving a search request from an entity comprising a list of attributes;
generating a list of users with public attributes on the distributed ledger with at least one attribute on the list of attributes;
transmitting the list of users to the entity;
receiving, from the entity, requests for access to subsets of user data of a plurality of users from the list of users;
rendering a second GUI for receiving, from the user, input identifying a response to the request for the entity;
providing, using the network interface, the second GUI to a user device associated with the user for display to the user;
receiving, from the user device and using the network interface, the response for the entity input by the user using the second GUI; and
transmitting the response, using the network interface, to the entity.

16. The method of claim 15, wherein each request for access of the requests for access from the entity to the plurality of users comprises:
a subset of user data the entity is allowed to access;
a duration of allowed use of the subset of the user data;
restrictions on the allowed use of the subset of the user data;
permissions regarding the entity distributing access to the subset of the user data to other entities; and
an offer of resources provided by the entity for access to the subset of the user data.

17. The method of claim 16, wherein the response to the request comprises an agreement to the request, a rejection of the request, or an amendment to terms of the request.

18. The method of claim 17, wherein, if the response comprises an agreement, the method comprises:
generating, using the network interface, a smart contract on the distributed ledger that permits devices with a token to access the subset of the user data; and
providing, using the network interface, the token to a device associated with the entity.

19. The method of claim 16, comprising a generative AI model configured for:
receiving, using the network interface, the requests for access to subsets of user data of the plurality of users from the list of users;
analyzing the requests for access;
generating data of the requests for access;
analyzing a request of the requests for access;
generating a recommendation for the request; and
transmitting, using the network interface, the data of the requests for access and the recommendation for the request to a user associated with the request.

20. The method of claim 15, wherein the method comprises:
rendering a third GUI comprising an up-to-date list of entities with active access to a subset of the user data; and
providing, using the network interface, the third GUI to the user device associated with the user for display to the user.
